(19) United States
(12) Patent Application Publication
(10) Pub. No.: US 2013/0096046 A1
(43) Pub. Date: Apr. 18, 2013

(54) SOAP STRUCTURE

(71) Applicant: Wei Liu, NEW TAIPEI CITY (TW)

(72) Inventor: Wei Liu, NEW TAIPEI CITY (TW)

(73) Assignee: FRESH SPRING INTERNATIONAL, INC., NEW TAIPEI CITY (TW)

(21) Appl. No.: 13/271,557

(22) Filed: Oct. 12, 2011

(51) Int. Cl. C11D 17/00

(52) U.S. Cl. 510/447

(57) ABSTRACT

A soap structure includes a core portion having dimensions defined according to general users' palm size for a user to conveniently grip it; and at least one layer of soap portion being covered over the core portion, so that the core portion is completely enclosed in the soap portion. With the core portion being sized suitable for gripping and covered by one or more layers of soap portion, the soap structure can be conveniently gripped even if the layers of soap portion gradually reduce in mass and size after being used many times.

### FIELD OF THE INVENTION

The present invention relates to a soap structure, and more particularly to a soap structure that can be conveniently gripped even if the soap portion thereof gradually reduces in mass and size after being used many times.

### BACKGROUND OF THE INVENTION

Most of the currently available soaps are in the shape of a solid bar or block and have a size suitable for gripping, so that a user can conveniently grip the soap for cleaning. After being used many times, the soap is dissolved by water and gradually reduces in mass and size. With the small size, the soap can not be easily gripped and tends to slip off the user's hand to cause inconvenience in using it. People would usually discard such small pieces of soap because they are not convenient for use. Therefore, a lot of soaps is unnecessarily wasted.

Further, hotels or inns would usually provide only small-size soaps in bathrooms because guests won't use the soaps many times during their stay in the hotels or inns. Such small-size soaps are inconvenient for use, and in view of hygienic requirements, they are usually discarded and not recycled once they have been used. This also causes unnecessary waste of soap.

It is therefore desirable to develop a soap structure that can still be conveniently gripped for use even if the soap portion thereof is reduced in mass and size after being used many times.

### SUMMARY OF THE INVENTION

A primary object of the present invention is to provide a soap structure that can be conveniently gripped even if the soap portion thereof gradually reduces in mass and size after being used many times, so as to avoid unnecessary waste caused by discarding used soap that is reduced in size and inconvenient for gripping.

Another object of the present invention is to provide a soap structure that has a specific gravity smaller than water and can therefore float on water to save a user from the trouble of locating and scooping up a piece of soap sunken into water.

To achieve the above and other objects, the soap structure according to the present invention includes a core portion having dimensions defined according to general users' palm size for a user to conveniently grip it; and at least one layer of soap portion being covered over the core portion, so that the core portion is completely enclosed in the soap portion.

In an operable embodiment, the core portion internally defines a hollow space and is made of a lightweight material.

In a preferred embodiment, the soap portion is formed of one single layer of first soap portion.

In another preferred embodiment, the soap portion is formed of a layer of first soap portion and a layer of second soap portion.

In an operable embodiment, the layer of first soap portion is completely covered by the layer of second soap portion.

In another operable embodiment, the layer of first soap portion is partially covered by the layer of second soap portion, so that part of the first soap portion is exposed to air.

In a further preferred embodiment, the soap portion is formed of three or more layers of soap portion.

Further, at least one type of coloring and/or at least one type of scent can be added to the soap portion.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a soap structure with one single layer of soap portion according to a first embodiment of the present invention;

FIG. 2 is a cross-sectional perspective view taken along line A-A′ of FIG. 1;

FIG. 3 is a cross-sectional perspective view of a soap structure with two layers of soap portion according to a second embodiment of the present invention; and

FIG. 4 is a cross-sectional perspective view of a soap structure with three layers of soap portion according to a third embodiment of the present invention.

### DETAILED DESCRIPTION OF THE PREFERRED EMBODIMENTS

The present invention will now be described with some preferred embodiments thereof and with reference to the accompanying drawings. For the purpose of easy to understand, elements that are the same in the preferred embodiments are denoted by the same reference numerals.

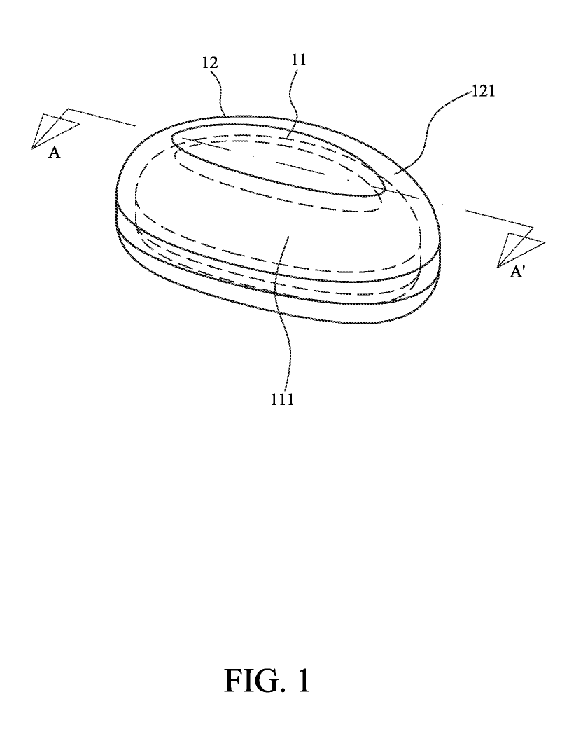

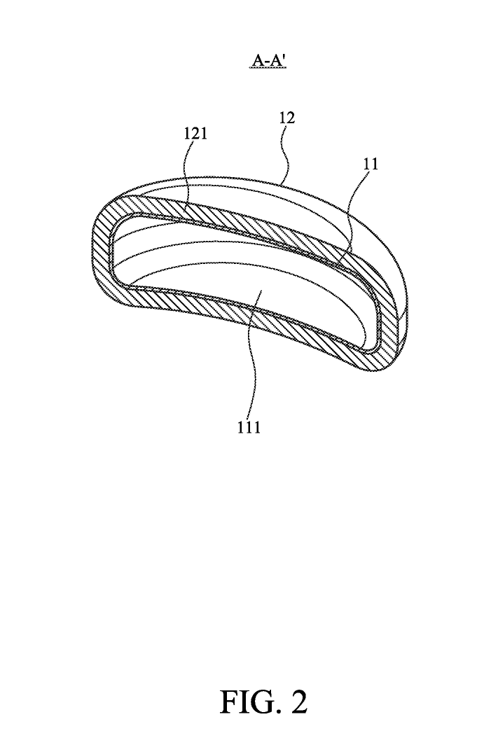

Please refer to FIG. 1 that is a perspective view of a soap structure according to a first embodiment of the present invention, and to FIG. 2 that is a cross-sectional perspective view taken along line A-A′ of FIG. 1. As shown, the soap structure according to the present invention includes a core portion 11 and a layer of soap portion 12 covering the core portion 11, so that the core portion 11 is completely enclosed in the layer of soap portion 12. The core portion 11 has dimensions defined according to general users' palm size, so that it can be conveniently gripped by a user.

In an operable embodiment of the present invention, the core portion 11 internally defines a hollow space 111, and is made of a lightweight material. With the core portion 11 having a hollow space 111, the soap structure according to the present invention can have a specific gravity smaller than the buoyancy of water, and can therefore float on water without becoming sunken thereinto. With this structure, a user is saved from the trouble of locating and scooping up a piece of soap sunken into water.

In a preferred embodiment, the soap portion 12 is formed by setting a liquid soap-making mixture. The liquid soap-making mixture includes at least water, oil, and sodium hydroxide which are mixed with one another. To make the soap structure of the present invention, first immerse the core portion 11 in the liquid soap-making mixture, so that the whole core portion 11 is covered by the liquid soap-making mixture. Then, air-dry the core portion 11 for the liquid soap-making mixture to set and form a layer of first soap portion 121 over the whole core portion 11. In this manner, a piece of soap suitable for one-time use in hotels or inns is formed. With the layer of first soap portion 121 being molded over the core portion 11, which is dimensioned according to palm size and therefore provides a relatively large volume, the soap structure of the present invention can still be conveniently gripped even if the soap portion 12 thereof reduces in mass and size after being used many times.

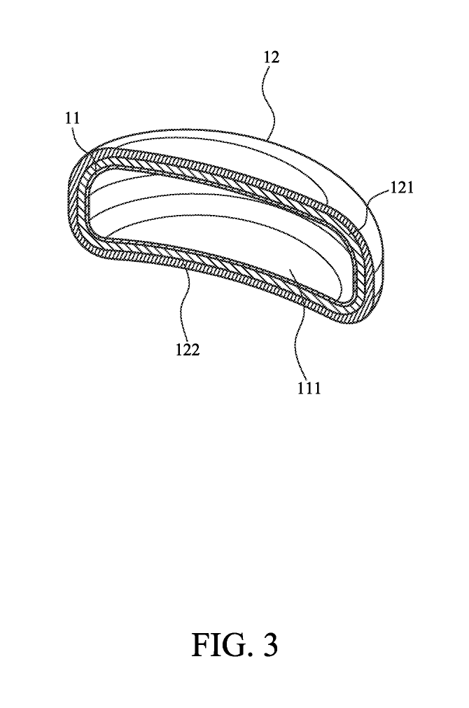

FIG. 3 is a cross-sectional perspective view of a soap structure according to a second embodiment of the present invention. In the second embodiment, the immersion and air-drying process is repeated twice, so that the layer of first soap portion 121 set over the core portion 11 is completely covered by a layer of second soap portion 122. Therefore, the core portion 11 is covered by two layers of soap portion 121, 122 to provide a piece of repeatedly usable soap.

While the second embodiment of the present invention is described with the layer of first soap portion 121 being completely covered by the layer of second soap portion 122, it is understood the soap structure of the present invention is not limited thereto. That is, the layer of second soap portion 122 can be otherwise formed to cover only part of the layer of first soap portion 121, so that the layer of first soap portion 121 is partially exposed to air.

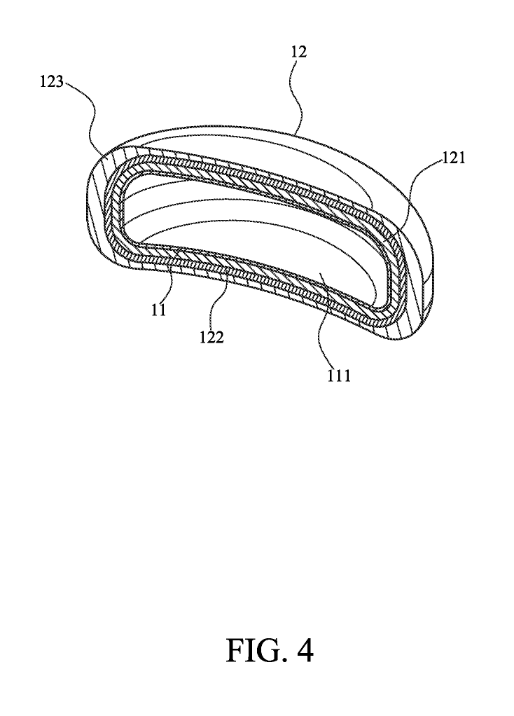

Please refer to FIG. 4 that is a cross-sectional perspective view of a soap structure according to a third embodiment of the present invention. According to users' actual need, the above-mentioned immersion and air-drying process can be repeated three times, so that a layer of first soap portion 121, a layer of second soap portion 122, and a layer of third soap portion 123 are sequentially covered over the core portion 11.

While the third embodiment of the present invention is described with three layers of soap portion 121, 122, 123, it is understood the soap structure of the present invention is not limited thereto. That is, the immersion and air-drying process can be repeated more than three times, so that more than three layers of the soap portion 12 can be sequentially formed to cover the core portion 11.

Further, depending on users' preference, at least one type of coloring can be added to the liquid soap-making mixture, so that the soap portion 12 covering the core portion 11 is colored. By sequentially immersing the core portion 11 in differently colored liquid soap-making mixtures and air-drying the core portion 11, a soap structure with a core portion 11 and multiple layers of soap portion 12 showing different colors from inner to outer layers can be obtained.

Furthermore, at least one type of scent can also be added to the liquid soap-making mixture according to the users' preference, so that a perfumed soap is completed.

In brief, the present invention provides a soap structure that includes a core portion being sized suitable for gripping and covered by one or more layers of soap portion, so that the soap structure can be conveniently gripped even if the layers of soap portion gradually reduce in mass and size after being used many times.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A soap structure comprising a core portion having dimensions defined according to general users' palm size for a user to conveniently grip it; and at least one layer of soap portion being covered over the core portion, so that the core portion is completely enclosed in the soap portion.

2. The soap structure as claimed in claim 1, wherein the core portion internally defines a hollow space.

3. The soap structure as claimed in claim 1, wherein the core portion is made of a lightweight material.

4. The soap structure as claimed in claim 1, wherein the soap portion has at least one type of coloring added thereto.

5. The soap structure as claimed in claim 1, wherein the soap portion has at least one type of scent added thereto.

6. The soap structure as claimed in claim 1, wherein the soap portion is formed of one single layer of first soap portion.

7. The soap structure as claimed in claim 1, wherein the soap portion is formed of a layer of first soap portion and a layer of second soap portion.

8. The soap structure as claimed in claim 7, wherein the layer of first soap portion is completely covered by the layer of second soap portion.

9. The soap structure as claimed in claim 7, wherein the layer of first soap portion is partially covered by the layer of second soap portion, so that part of the first soap portion is exposed to air.

10. The soap structure as claimed in claim 1, wherein the soap portion is formed of at least three layers of soap portion.
